(19) United States
(12) Patent Application Publication
(10) Pub. No.: US 2005/0264706 A1
(43) Pub. Date: Dec. 1, 2005

(54) Image forming apparatus and projection TV set having the same

(75) Inventor: Kee-uk Jeon, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/126,174

(22) Filed: May 11, 2005

(30) Foreign Application Priority Data
May 11, 2004 (KR) 10-2004-0033097

(51) Int. Cl. H04N 9/31

(52) U.S. Cl. 348/744; 348/743

(57) ABSTRACT

An image forming apparatus and a projection TV set having the same are provided. The image forming apparatus includes an illumination system and a projection system which enlarges and projects a color image from the illumination system onto a screen. The illumination system includes a light source; a color separator which separates light from the light source into separate colors; an integrator which shapes the light from the color separator; a display device which processes the incident light in response to an input signal and which forms a color image; a condensing element which directs the light from the light source to the display device and which transmits the light from the display device; and at least one light-path converter which bends the light from the light source upwards. The projection system is disposed at a different height in a vertical direction than the illumination system.

### CROSS-REFERENCE TO RELATED PATENT APPLICATIONS

This application claims the benefit of Korean Patent Application No. 10-2004-0033097, filed on May 11, 2004, in the Korean Intellectual Property Office, the disclosure of which is incorporated herein in its entirety by reference.

### BACKGROUND OF THE INVENTION

1. Field of the Invention

The present invention relates to an image forming apparatus having an improved structure in which an illumination system and a projection system are disposed at different heights to be suitably mounted in a stand-shaped cabinet, and to a projection TV set including the image forming apparatus.

2. Description of the Related Art

Conventional projection systems are largely classified as either a three-panel projection system or a single-panel projection system depending on the number of display devices that perform on-off control of light emitted from a light source in units of pixels. The light source is a high-powered lamp which produces a color image. In a single-panel projection system, the structure of the optical system can be reduced in size, in comparison to the three-panel projection system. However, white light is separated into red (R), green (G), and blue (B) colors using a sequential method, and thus, the photoefficiency of a single-panel projection system is ⅓ the photoefficiency of a three-panel projection system. Thus, efforts for increasing photoefficiency of single-panel projection systems have been made.

In a conventional single-panel projection system, a beam irradiated from a white light source is separated into R, G, and B color beams using a color filter, and each color beam is sequentially transferred to a display device. The display device is operated sequentially, in the order of the colors received, so as to form an image.

As shown in FIG. 1A, a conventional single-panel projection system includes a light source 10; a color wheel 15 through which a beam emitted from the light source 10 passes; an integrator 17 which shapes the beam that has passed through the color wheel 15; a total reflection prism 25 which totally reflects the beam that has passed through the integrator 17; and a display device 27 which receives the beam reflected by the total reflection prism 25, processes the beam according to an input image signal, and forms a color image. The system further includes a projection system 30 which enlarges and projects the color image formed by the display device 27 onto a screen.

An ultraviolet interception filter 12 is disposed between the light source 10 and the color wheel 15, and a lens group 20, which condenses the beam that has passed through the integrator 17, is disposed on a light path between the integrator 17 and the total reflection prism 25.

The total reflection prism 25 includes an incidence prism 25a which totally reflects the beam emitted from the light source 10 onto the display device 27; and an emission prism 25b which transmits the beam reflected by the display device 27 to the projection system 30.

The entire device, from the light source 10 to the projection system 30, has a horizontal structure with a width which is, relative to its height, very large.

FIG. 1B shows a projection TV set having a cabinet 40 which contains a screen unit 35 on which a screen S is mounted. Inside the cabinet 40, an image forming apparatus is installed. Reference numeral 42 denotes a decoration cabinet.

The image forming apparatus having the horizontal structure shown in FIG. 1A is advantageous to be installed in the cabinet 40 extending in a horizontal direction, as shown in FIG. 1B. The conventional image forming apparatus is suitable for a projection TV set having a shape similar to a desktop monitor.

However, customers desire projection TV sets having a variety of designs. Thus, in order to change the appearance of the projection TV set, the structure of the image forming apparatus needs to be changed.

### SUMMARY OF THE INVENTION

The present invention provides an image forming apparatus that can be suitably installed in a cabinet having a stand or pillar shape extending vertically, and a projection TV set having the same.

According to an aspect of the present invention, there is provided an image forming apparatus including: an illumination system and a projection system which enlarges and projects a color image formed by the illumination system onto a screen. The illumination system includes: a light source; a color separator which separates the light irradiated from the light source into separate colors; an integrator which shapes the light that has passed through the color separator; a display device which processes the incident light in response to an input signal and which forms a color image; a condensing element which directs the light irradiated from the light source to the display device and which transmits the light reflected by the display device; and at least one light-path converter which bends the light irradiated from the light source upwards. The projection system is disposed at a different height in a vertical direction than the illumination system.

The at least one light-path converter may include a first light-path converter which bends the light emitted from the light source upwards so that the image forming apparatus can be suitably installed in a stand-shaped cabinet, and a second light-path converter which directs the light to be incident on the display device at an optimum angle.

If a vertical direction of the display device is the Z-axis, and the angle between the normal of the first light-path converter and the Z-axis is θ₁, then θ₁ may have an angle between 0° and 90°.

If a vertical direction of the display device is the Z-axis, the angle between the normal of the first light-path converter and the Z-axis is θ₂, and the light reflected from the first light-path converter propagates at an angle α with respect to the Z-axis, θ₂ may be given by:

$${45}^{°} - \frac{α}{2} < {θ}_{2} < {90}^{°} + \frac{α}{2} .$$

According to another aspect of the present invention, there is provided an image forming apparatus including: an illumination system and a projection system which enlarges and projects a color image formed by the illumination system onto a screen. The illumination system includes: a light source which emits light horizontally with respect to a ground; a color separator which separates the light irradiated from the light source into separate colors; an integrator which shapes the light that has passed through the color separator; a display device which processes the incident light in response to an input signal and which forms a color image; a condensing element which directs the light irradiated from the light source to the display device and which transmits the light reflected by the display device; and a light-path converter which bends light irradiated from the light source upwards. The projection system is disposed at a different height in a vertical direction than the illumination system.

If a vertical direction of the display device is the Z-axis, the angle between the normal of the light-path converter and the Z-axis is θ, and the light reflected by the light-path converter propagates at an angle α with respect to the Z-axis, θ may be given by:

$$θ = ( {90}^{°} + \frac{α}{2} ) \pm {10}^{°} .$$

According to still another aspect of the present invention, there is provided a projection TV set including a screen unit and a cabinet comprising an image forming apparatus. The image forming apparatus is disposed vertically in the cabinet, and the cabinet is pillar-shaped and has a smaller width than the screen unit.

### BRIEF DESCRIPTION OF THE DRAWINGS

The above aspects and advantages of the present invention will become more apparent by describing in detail exemplary embodiments thereof with reference to the attached drawings in which:

FIG. 1A is a schematic diagram of a conventional image forming apparatus;

FIG. 1B shows the appearance of a projection TV set having a conventional image forming apparatus;

FIG. 2 shows the appearance of a projection TV set having an image forming apparatus according to an embodiment of the present invention;

FIG. 3 is a schematic diagram of an image forming apparatus according to another embodiment of the present invention;

FIG. 4 shows the structure and coordinate system of a deformable micromirror device (DMD) used in an image forming apparatus according to another embodiment of the present invention;

FIG. 5A shows a light path of a beam reflected upwards by a first light-path converter used in the image forming apparatus shown in FIG. 3;

FIG. 5B is a schematic diagram of the gradient of the first light-path converter, at which a beam is reflected upwards by the first light-path converter used in the image forming apparatus shown in FIG. 3;

FIG. 6A is a schematic diagram of the arrangement of a second light-path converter and a display device which allows a beam to be incident on the display device at a predetermined angle after reflecting from the second light-path converter used in the image forming apparatus shown in FIG. 3;

FIGS. 6B, 6C, and 6D are schematic diagrams of the gradient of the second light-path converter at which a beam incident on the second light-path converter, used in the image forming apparatus shown in FIG. 3, is reflected at a predetermined angle;

FIG. 7 is a schematic diagram of a structure of an image forming apparatus according to another embodiment of the present invention; and

FIG. 8 is a schematic diagram of a modified example of the image forming apparatus shown in FIG. 7.

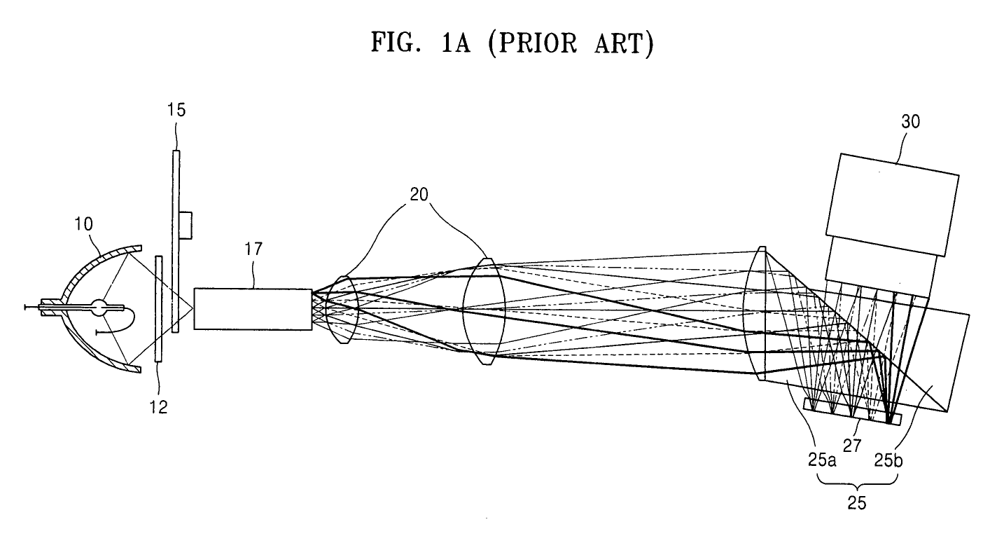

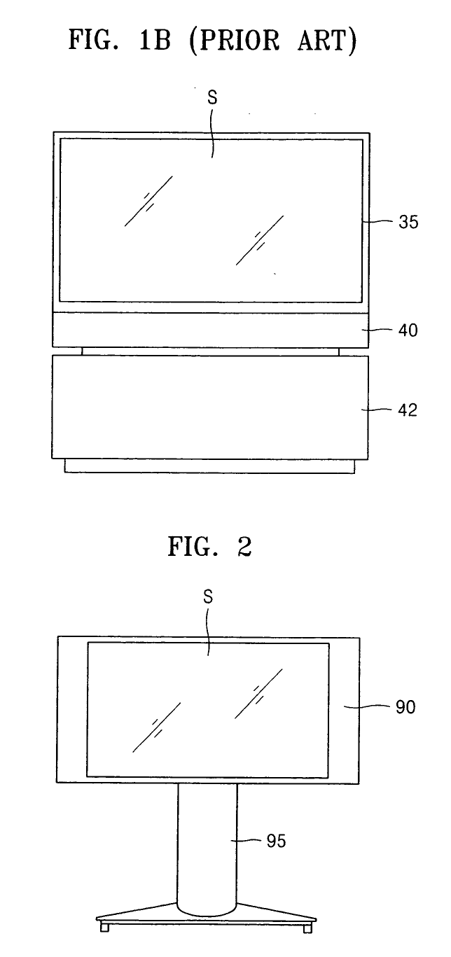

### DETAILED DESCRIPTION OF THE INVENTION

FIG. 2 shows a projection TV set having an image forming apparatus according to an embodiment of the present invention. The projection TV set of FIG. 2 includes a screen unit 90 having a screen S; and a cabinet 95 having a stand or pillar shape extending vertically and disposed under the screen unit 90.

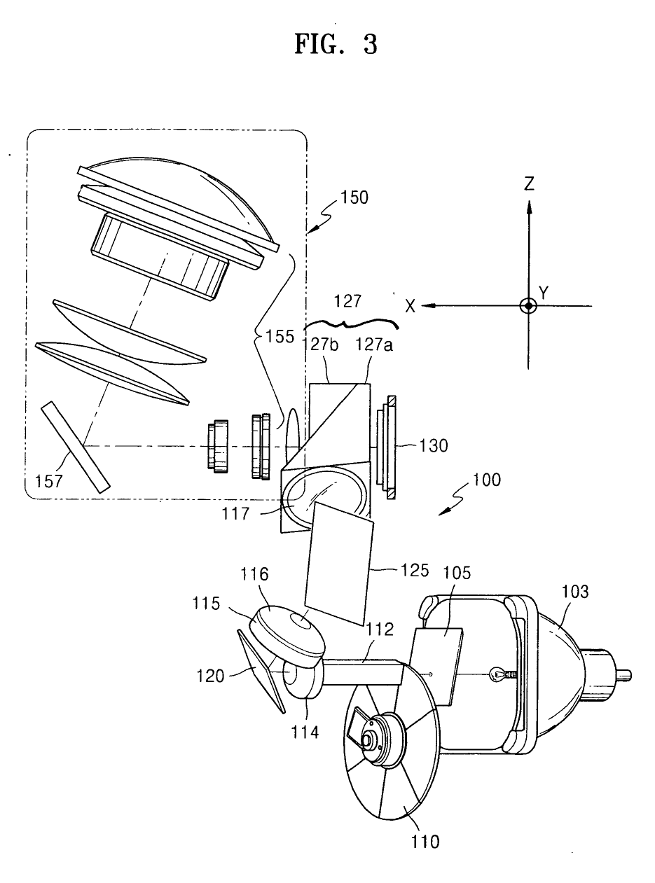

FIG. 3 is a schematic diagram of an image forming apparatus according to another embodiment of the present invention. The image forming apparatus of FIG. 3 includes an illumination system 100 which radiates a beam and forms a color image; and a projection system 150 which enlarges and projects the color image onto a screen S. The illumination system 100 and the projection system 150 are disposed at different heights in the vertical (Z) direction.

The illumination system 100 and the projection system 150 may be installed in the cabinet 95. The present invention is an improved structure relative to a prior-art structure in which the illumination system 100 and the projection system 150 are suitably installed in the cabinet 95 having a stand shape, as shown in FIG. 2.

The illumination system 100 includes a light source 103 which radiates a beam; a color separator 110 which separates the beam irradiated from the light source 103 into separate colors; and a display device 130 which processes the color beam that has passed through the color separator 110 in response to an input signal and forms a color image. In addition, in order to arrange the illumination system 100 to extend vertically, the illumination system 100 further includes at least one light-path converter which bends the beam irradiated from the light source 103 upwards. The projection system 150 enlarges and projects the color image formed on the display device 130 onto the screen S.

The illumination system 100 includes a first light-path converter 120 which is disposed between the color separator 110 and the display device 130 and converts the path of an incident beam into a first direction; a second light-path converter 125 which converts the path of the beam reflected by the first light-path converter 120 into a second direction; and a condensing element 127 which directs the beam reflected by the second light-path converter 125 to the display device 130 and directs the beam reflected by the display device 130 toward the projection system 150.

The light source 103 is disposed under the cabinet 95 so that the optical axis of the light source 103 is parallel to a bottom surface of the cabinet 95. A beam, which is emitted from the light source 103 and proceeds parallel to the bottom surface of the light source 103, is reflected upwards by the first light-path converter 120. In addition, the second light-path converter 125 directs the beam reflected by the first light-path converter 120 to the condensing element 127.

The color separator 110 may be, for example, a color wheel or another element as would be understood by one of skill in the art.

An ultraviolet interception filter 105 is disposed on a light path between the light source 103 and the color separator 110, and an integrator 112 which shapes the beam emitted from the light source 103, is disposed between the color separator 110 and the first light-path converter 120. The integrator 112 shapes the beam so that the beam has a cross section corresponding to the shape of the display device 130.

Lenses for condensing beams are disposed on a light path between the integrator 112 and the condensing element 127. For example, a first condensing lens 114 is disposed between the integrator 112 and the first light-path converter 120. Second and third condensing lenses 115 and 116 are disposed between the first light-path converter 120 and the second light-path converter 125. A fourth condensing lens 117 is disposed between the second light-path converter 125 and the condensing element 127.

The condensing element 127 creates different optical paths for the beam incident on the display device 130 and the beam reflected by the display device 130. The condensing element 127 may be a total reflection prism having first and second prisms 127a and 127b opposite one another. The first prism 127a which is an incidence prism, totally internally reflects an incident beam to be incident on the display device 130, and the second prism 127b, which is an emission prism, transmits the beam reflected by the display device 130 to the projection system 150. Alternatively, the condensing element 127 may include a concave mirror or lens for condensing the beam from the second light-path converter 125 onto the display device 130.

The display device 130 may be a reflection type liquid crystal display (LCD) or a deformable micromirror device (DMD).

The projection system 150 includes a projection lens group 155 which forms a color image on a screen; and a reflection mirror 157 which directs the path of a beam.

In the present embodiment, the first light-path converter 120 which directs the beam emitted from the light source upwards so that the image forming apparatus can be suitably installed in the cabinet having a stand shape, and the second light-path converter 125 which makes the beam incident on the display device 130 at an optimum angle, are mounted. In order to transfer the beam emitted from the light source 103 upwards, the first light-path converter 120 may be disposed at an angle which will be described later.

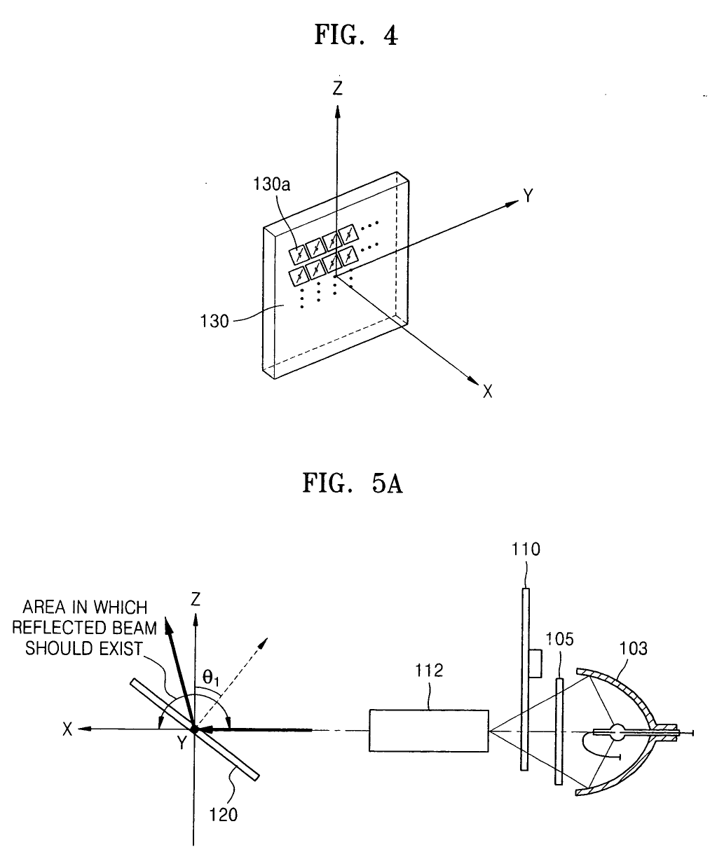

As shown in FIG. 4, in the DMD 130, a plurality of micromirrors 130a are arranged two-dimensionally, and the micromirrors 130a can be rotated separately. The reflected beam proceeds toward the projection system 150 or deviates from the projection system 150 depending on the direction of the micromirrors 130a such that the incident beam can be switched on or off.

Here, it is assumed that the direction perpendicular to the plane of the DMD 130 is the X-axis, the Z-axis is vertical and the Y-axis is defined by the conventions of a right-handed system. A coordinate system based on theses conventions is also used in FIG. 3.

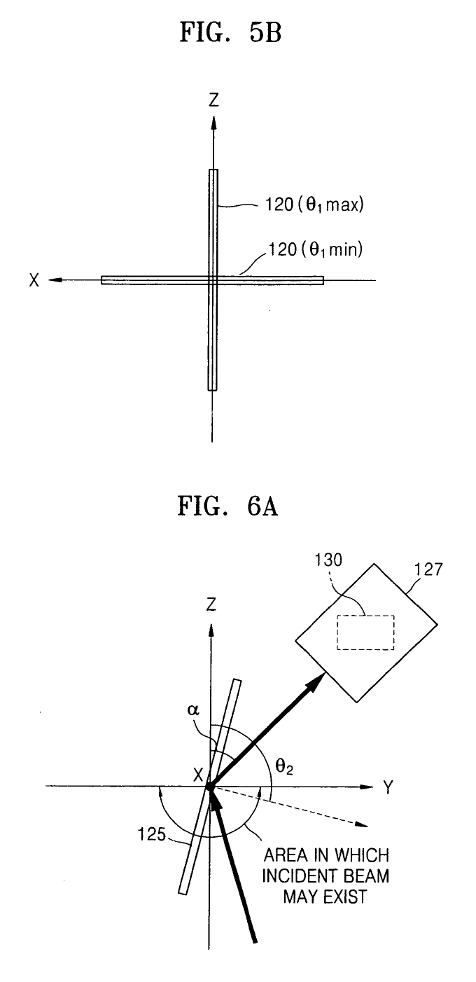

First, referring to FIG. 5A, in order to direct the beam reflected by the first light-path converter 120 upwards, an area is defined in which the beam reflected by the first light-path converter 120 should exist. That area is defined between the positive X-axis and the positive Z-axis, as shown in FIG. 5A. For explanatory convenience, FIG. 5A shows a group of optical elements disposed on a path from the light source 103 to the first light-path converter 120.

In order to satisfy these conditions, the angle between the normal of the first light-path converter 120 (illustrated as a dashed line in FIG. 5A) and the Z-axis (θ₁) is between 0° and 90°. Referring to FIG. 5B, when the first light-path converter 120 is parallel to the X-axis, θ₁ has a minimum value (θ₁ₘᵢₙ) of 0, θ₁ₘᵢₙ=0°. When the first light-path converter 120 is parallel to the Z-axis, θ₁ has a maximum value, θ₁ₘₐₓ=90°. The position of the first light-path converter 120, which transfers the beam emitted from the light source 103 upwards, is indicated by θ₁, and defined by relation 1.
0°<θ₁<90° (1)

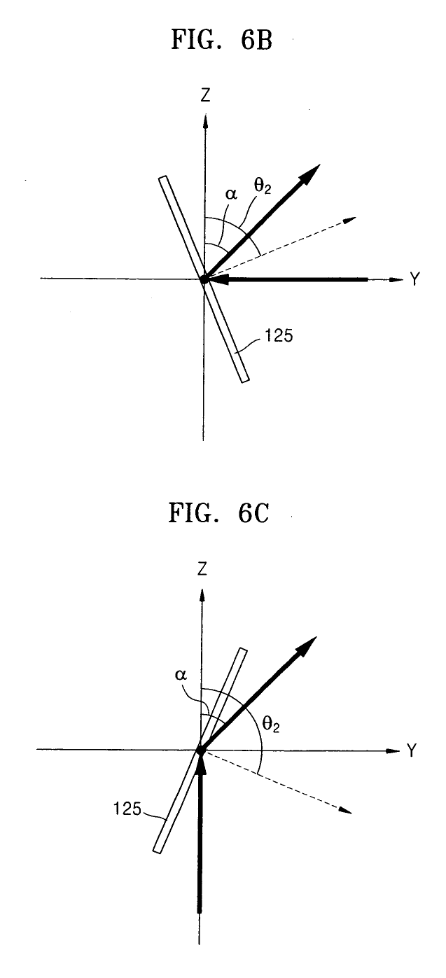

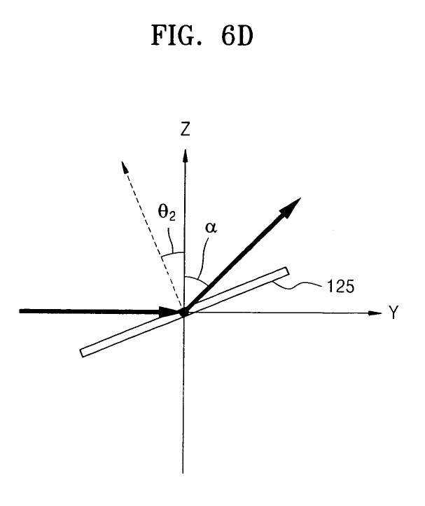

Next, referring to FIG. 6A, the beam reflected by the second light-path converter 125 is incident on the condensing element 127 at a predetermined angle α with respect to the Z-axis. In order to satisfy incident angle requirements, the gradient angle of the second light-path converter 125 is obtained as follows. That is, since the incident beam has been reflected by the first light-path converter 120 upwards, an area in which a beam incident on the second light-path converter 120 exists, and that area is defined by the negative Z-axis, as shown in FIG. 6A.

Here, the beam reflected from the second light-path converter 125 has an angle α with respect to the Z-axis, and the angle between the Z-axis and the normal of the second light-path converter 125 (illustrated as a dashed line in FIG. 6A) is referred to as θ₂.

FIG. 6B shows the case where the beam is incident on the second light-path converter 125 along the (+)Y-axis. In this case, θ₂ is (45+α/2) degrees. FIG. 6C shows the case where the beam is incident on the second light-path converter 125 along the (−)Z-axis. In this case, θ₂ is (90+α/2) degrees.

FIG. 6D shows the case where the beam is incident on the second light-path converter 125 along the (−)Y-axis. In this case, θ₂ is (45−α/2) degrees.

Referring to FIGS. 6B, 6C, and 6D, in order to direct the beam reflected by the second light-path converter 125 at an angle α with respect to the Z-axis, the following conditions may apply:

$${45}^{°} - \frac{α}{2} < {θ}_{2} < {90}^{°} + \frac{α}{2} \qquad ( 2 )$$

For example, when the display device 130 is a DMD, and the beam reflected by the second light-path converter 125 is incident on the condensing element 127 at an angle of 45 degrees, with respect to the Z-axis, θ₂ is given by relation 2.
225°<θ₂<1125° (3)

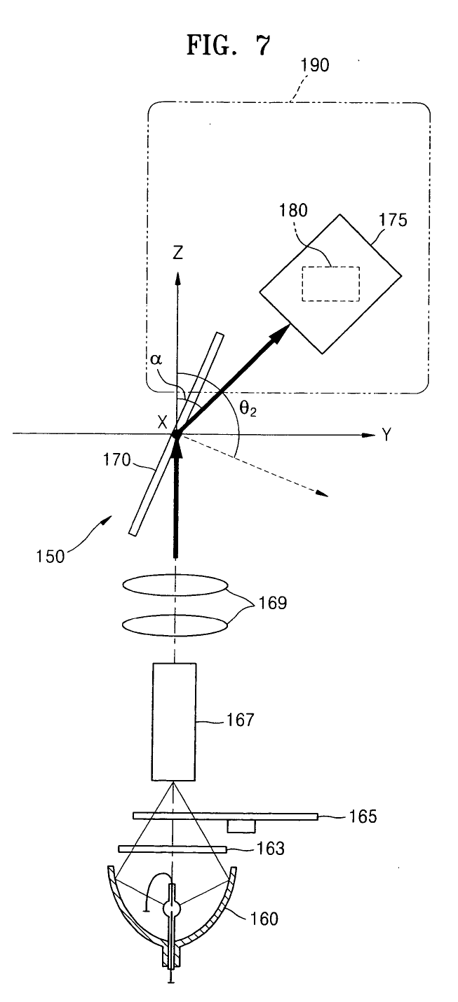

Next, as shown in FIG. 7, the image forming apparatus according to another embodiment of the present invention includes a light source 160 for radiating a beam onto a bottom surface of the image forming apparatus in a vertical (Z) direction; a color separator 165 which separates the beam irradiated from the light source 160 into separate colors; an illumination system 150 having a display device 180 which processes the color beam separated by the color separator 165 in response to an input image signal and forms a color image; and a projection system 190 which enlarges and projects the color image formed by the illumination system 150 onto a screen.

In addition, the image forming apparatus further includes a light-path converter 170 which directs the path of a beam so that it is incident on the display device 180 at a predetermined angle. An ultraviolet interception filter 163 for absorbing ultraviolet rays is disposed on a light path between the light source 160 and the color separator 165, and an integrator 167 which shapes an incident beam, and a condensing lens group 169 which condenses the beam that has passed through the integrator 167, are disposed on a light path between the color separator 165 and the light-path converter 170.

The color separator 165 may be, for example, a color wheel or another element as would be understood by one of skill in the art.

A condensing element 175 is disposed on a light path between the light-path converter 170 and the display device 180. The condensing element 175 directs the beam from the light-path converter 170 to the display device 180 and transfers the beam reflected by the display device 180 to the projection system 190.

In the present embodiment, one light-path converter 170 is mounted so that the illumination system 150 and the projection system 190 are disposed at different heights. Here, it is assumed that a direction perpendicular to the plane of the display device 180 is the X-axis, the Z-axis is vertical and the Y-axis is defined by the conventions of a right-handed system.

The light-path converter 170 directs the beam emitted from the light source 160 to the condensing element 175 at an angle α with respect to the Z-axis. The light source 160 emits the beam in a direction perpendicular to a bottom surface, that is, in a direction parallel to the Z-axis. In addition, the beam emitted from the light source 160 is reflected upwards by the light-path converter 170 at a predetermined angle, α, with respect to the Z-axis. Here, the angle between the Z-axis and the normal of the light-path converter 170 (illustrated by a dashed line in FIG. 7) is θ, which is (90+α/2) degrees. The tolerance of θ is given by relation 4.

$$θ = ( {90}^{°} + \frac{α}{2} ) \pm {10}^{°} \qquad ( 4 )$$

For example, when the display device 180 is a DMD, and the beam reflected by the light-path converter 170 is incident on the condensing element 175 at an angle of 45 degrees with respect to the Z-axis, θ is given by relation 5.
θ=112.5°±10° (5)

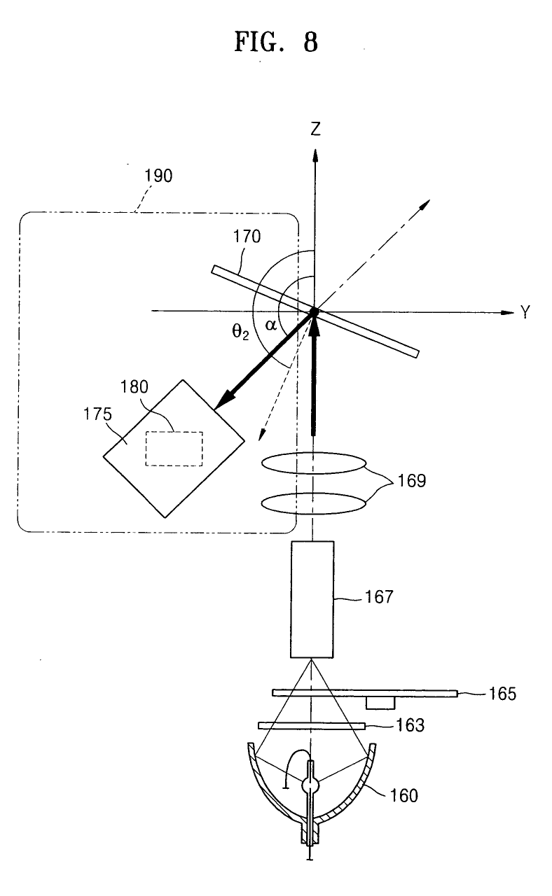

Next, in the image forming apparatus shown in FIG. 8, the beam emitted from the light source can be bent downwards by using a light-path converter.

The structure in FIG. 8 is different from the structure in FIG. 7 in that the optical path of a beam is changed into a downward path by the light-path converter 170. Referring to FIG. 8, the condensing element 175 and the display device 180 are disposed under the light-path converter 170. In this case, a beam reflected by the light-path converter 170 may be incident on the display device 180 at an angle of 135 degrees, with respect to the Z-axis.

In order to bend the beam emitted from the light source 160 downwards, relation 4 dictates that the angle between normal of the light-path converter 170 and the Z-axis be given by relation 6.
θ=157.5°±10° (6)

In this way, the beam emitted from the light source 160 can proceed in a direction perpendicular to the bottom surface of the light source 160, and the appearance of the image forming apparatus can be diverse.

According to the embodiments of the present invention, a cabinet in which an illumination system and a projection system are received can extend in a lengthwise direction, and thus, the appearance of the image forming apparatus can be different from the appearance of a conventional image forming apparatus. In other words, the illumination system and the projection system can be easily mounted in a cabinet having a stand or pillar shape, as shown in FIG. 2.

As described above, in the image forming apparatus according to the present invention, the illumination system and the projection system for radiating beams are disposed so as to extend in a vertical direction and thus, can be easily mounted in a cabinet having a vertically-extending stand or pillar shape.

Accordingly, the projection TV set having the image forming apparatus according to the present invention has a stand shape, so in the same, the projection TV set can have a variety of designs in order to satisfy customers' desires.

While the present invention has been particularly shown and described with reference to exemplary embodiments thereof, it will be understood by those skilled in the art that various changes in form and details may be made therein without departing from the spirit and scope of the invention as defined by the following claims.

1. An image forming apparatus comprising:
an illumination system comprising:
a light source;
a color separator which separates the light irradiated from the light source into separate colors;
an integrator which shapes the light that has passed through the color separator;
a display device which processes the light from the integrator in response to an input signal and which forms a color image;
a condensing element which directs the light irradiated from the light source to the display device and which transmits the light reflected by the display device; and
at least one light-path converter, disposed on a light path between the light source and the display device, which bends the light irradiated from the light source upwards; and
a projection system which enlarges and projects the color image formed by the illumination system onto a screen, the projection system being disposed at a different height, in a vertical direction, than the illumination system.

2. The image forming apparatus of claim 1, wherein the light source emits a beam perpendicularly with respect to the vertical direction.

3. The image forming apparatus of claim 1, wherein the at least one light-path converter comprises a first light-path converter which bends the light emitted from the light source upwards so that the image forming apparatus can be suitably installed in a stand-shaped cabinet, and a second light-path converter which directs the light to be incident on the display device.

4. The image forming apparatus of claim 3, wherein, if a vertical direction of the display device is the Z-axis, and the angle between the normal of the first light-path converter and the Z-axis is θ₁, then θ₁ has an angle between 0° and 90°.

5. The image forming apparatus of claim 3, wherein, if a vertical direction of the display device is the Z-axis, and the angle between the normal of the first light-path converter and the Z-axis is θ₂, and the light reflected by the first light-path converter propagates at an angle α with respect to the Z-axis, θ₂ is given by:
$${45}^{°} - \frac{α}{2} < {θ}_{2} < {90}^{°} + \frac{α}{2} .$$

6. The image forming apparatus of claim 3, wherein, if the display device is a deformable micromirror device (DMD), a vertical direction of the display device is the Z-axis, the angle between the normal of the first light-path converter and the Z-axis is θ₂, and the light reflected by the first light-path converter propagates at an angle of 45 degrees with respect to the Z-axis, θ₂ is given by:
22.5°<θ₂<112.5°.

7. An image forming apparatus comprising:
an illumination system comprising:
a light source which emits light horizontally with respect to a ground;
a color separator which separates the light irradiated from the light source into separate colors;
an integrator which shapes the light that has passed through the color separator;
a display device which processes the light form the integrator in response to an input signal and which forms a color image;
a condensing element which directs the light irradiated from the light source to the display device and which transmits the light reflected by the display device; and
a one light-path converter, disposed on a light path between the light source and the display device which bends the light irradiated from the light source upwards; and
a projection system which enlarges and projects the color image formed by the illumination system onto a screen, the projection system being disposed at a different height in a vertical direction than the illumination system.

8. The image forming apparatus of claim 7, wherein, if a vertical direction of the display device is the Z-axis, the angle between the normal of the light-path converter and the Z-axis is θ, and the light reflected by the light-path converter propagates at an angle α with respect to the Z-axis, θ is given by:
$$θ = ( {90}^{°} + \frac{α}{2} ) \pm {10}^{°} .$$

9. The image forming apparatus of claim 8, wherein, if the display device is a deformable micromirror device (DMD) and extends vertically in the direction of the Z-axis, the angle between the normal of the light-path converter and the Z-axis is θ, and the light reflected by the light-path converter propagates at an angle of 45 degrees with respect to the Z-axis, θ is given by:
θ=112.5°±10°.

10. A projection TV set, comprising:
a screen unit, and
a cabinet comprising an image forming apparatus;
wherein the image forming apparatus comprises:
an illumination system comprising:
a light source;
a color separator which separates the light irradiated from the light source into separate colors;
an integrator which shapes the light that has passed through the color separator;
a display device which processes the incident light in response to an input signal and which forms a color image;
a condensing element which directs the light irradiated from the light source to the display device and which transmits the light reflected by the display device; and
at least one light-path converter which bends the light irradiated from the light source upwards; and
a projection system which enlarges and projects the color image formed by the illumination system onto a screen, the projection system being disposed at a different height in a vertical direction than the illumination system, and
wherein the cabinet extends vertically and has a smaller width than the screen unit.

11. The projection TV set of claim 10, wherein
the at least one light path converter comprises a first light-path converter which bends the light emitted from the light source upwards so that the image forming apparatus is suitably installed in the stand-shaped cabinet, and a second light-path converter which directs the light to be incident on the display device.

12. The projection TV set of claim 10, wherein, if a vertical direction of the display device is the Z-axis, and the angle between the normal of the first light-path converter and the Z-axis is θ₁, then θ₁ has an angle between 0° and 90°.

13. The projection TV set of claim 10, wherein, if a vertical direction of the display device is the Z-axis, the angle between the normal of the first light-path converter and the Z-axis is θ₂, and the light reflected by the first light-path converter propagates at an angle α with respect to the Z-axis, θ₂ is given by:
$${45}^{°} - \frac{α}{2} < {θ}_{2} < {90}^{°} + \frac{α}{2} .$$

14. A projection TV set comprising:
a screen unit, and
a cabinet comprising an image forming apparatus,
wherein the image forming apparatus comprises:
an illumination system comprising:
a light source which emits light horizontally with respect to a ground;
a color separator which separates the light irradiated from the light source into separate colors;
an integrator which shapes the light that has passed through the color separator;
a display device which processes the incident light in response to an input signal and which forms a color image;
a condensing element which directs the light irradiated from the light source to the display device and which transmits the light reflected by the display device; and
a light-path converter, disposed on a light path between the light source and the display device, which bends the light irradiated from the light source upwards; and
a projection system which enlarges and projects the color image formed by the illumination system onto a screen, the projection system being disposed at a different height in a vertical direction than the illumination system, and
wherein the cabinet extends vertically and has a smaller width than the screen unit.
